(19) United States
(12) Patent Application Publication
(10) Pub. No.: US 2026/0203672 A1
(43) Pub. Date: Jul. 16, 2026

(54) METHOD, DEVICE, AND MEDIUM FOR MODEL REASONING

(71) Applicant: Bytedance Technology Ltd., Grand Cayman (KY)

(72) Inventor: Andrew Estornell, Los Angeles, CA (US)

(21) Appl. No.: 19/559,725

(22) Filed: Mar. 6, 2026

(51) Int. Cl. G06N 20/20

(52) U.S. Cl. CPC G06N 20/20

(57) ABSTRACT

Embodiments of the present disclosure provide a method, device, and medium for model reasoning. The method comprises obtaining a plurality of candidate answers for a question. And the method further comprises determining, based on the plurality of candidate answers and a plurality of counts of the plurality of candidate answers, distribution information of the plurality of candidate answers. In addition, the method further comprises determining, based on the plurality of candidate answers and the distribution information of the plurality of candidate answers, an answer for the question.

### BACKGROUND

Test-time scaling methods such as majority vote aggregation and iterative refinement (e.g., self-reflection or multi-agent inference) improve reasoning performance by leveraging multiple solution samples.

### SUMMARY

In a first aspect according to some embodiments of the present disclosure, a method comprises obtaining a plurality of candidate answers for a question. The method further comprises determining, based on the plurality of candidate answers and a plurality of counts of the plurality of candidate answers, distribution information of the plurality of candidate answers. In addition, the method further comprises determining, based on the plurality of candidate answers and the distribution information of the plurality of candidate answers, an answer for the question.

In a second aspect according to some embodiments of the present disclosure, an electronic device comprising a memory and one or more processors is provided. The memory is configured to store computer instructions which, when executed by the one or more processors, cause the one or more processors to obtain a plurality of candidate answers for a question. And the instructions may further cause the one or more processors to determine, based on the plurality of candidate answers and a plurality of counts of the plurality of candidate answers, distribution information of the plurality of candidate answers. In addition, the instructions may further cause the one or more processors to determine, based on the plurality of candidate answers and the distribution information of the plurality of candidate answers, an answer for the question.

In a third aspect according to some embodiments of the present disclosure, a non-transitory computer-readable medium is provided. The medium comprises instructions stored thereon which, when executed by one or more processors, cause the one or more processors to obtain a plurality of candidate answers for a question. And the instructions may further cause the one or more processors to determine, based on the plurality of candidate answers and a plurality of counts of the plurality of candidate answers, distribution information of the plurality of candidate answers. In addition, the instructions may further cause the one or more processors to determine, based on the plurality of candidate answers and the distribution information of the plurality of candidate answers, an answer for the question.

Any of the one or more above aspects in combination with any other of the one or more aspects is described herein. This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Embodiments of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with reference to the following figures.

FIG. 1 shows an overall architecture and application scenario in which one or more embodiments of the present disclosure may be implemented according to some embodiments of the present disclosure;

FIG. 2 is a flow chart illustrating an example process for improving model reasoning according to some embodiments of the present disclosure;

FIGS. 3A and 3B show a schematic comparison of processing concentrated errors and diverse errors and how error diversity affects inference-time scaling according to embodiments of this disclosure;

FIG. 4 is a flow chart illustrating an example process for anti-votes according to some embodiments of the present disclosure;

FIG. 5 is a flow chart illustrating an example process for training a model according to some embodiments of the present disclosure;

FIGS. 6A, 6B and 6C show a schematic outline of Diverse Failure Unified Success via Error (D-FUSEr) training framework according to embodiments of this disclosure;

FIG. 7 is a block diagram illustrating physical components (for example hardware) of an electronic device with which aspects of the present disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects may be practiced as methods, systems or devices. Accordingly, aspects may take the form of a hardware implementation, an entirely software implementation, or an implementation combining software and hardware aspects. The following detailed description is therefore not to be taken in a limiting sense, and the scope of the present disclosure is defined by the appended claims and their equivalents. A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “comprising” used herein and variations thereof are an open-ended inclusion, namely, “comprising but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description. Concepts such as “first” and “second” mentioned in the present disclosure are only for distinguishing different apparatuses, modules, or units, and are not intended to limit the order or relation of interdependence of functions performed by these apparatuses, modules, or units. Variants of “one” and “a plurality of” mentioned in the present disclosure are illustrative and not restrictive, and those skilled in the art should understand that unless otherwise explicitly specified in the context, the modifiers should be understood as “one or more”. The names of messages or information exchanged between apparatuses in the implementations of the present disclosure are provided for illustrative purposes only, and are not used to limit the scope of these messages or information. Data (comprising the data itself, and data acquisition, or usage) involved in the technical solutions should comply with the requirements of corresponding laws and regulations, and relevant stipulations.

As mentioned above, Test-time scaling methods such as majority vote aggregation and iterative refinement (e.g., self-reflection or multi-agent inference) improve reasoning performance by leveraging multiple solution samples. However, standard self-refinement methods condition each update on a single previous response or its critique. While effective in some settings, this approach can fail when the model repeatedly produces the same incorrect answer, causing refinement trajectories to collapse.

To address this limitation, the present disclosure proposes a method of distributional reflection, which conditions updates on the distribution of solutions produced by the model. Therefore, it can be seen that a method or system for model reasoning is needed. Exemplarily, the embodiments of the present disclosure propose a method suitable for model reasoning. The method comprises obtaining a plurality of candidate answers for a question. And the method further comprises determining, based on the plurality of candidate answers and a plurality of counts of the plurality of candidate answers, distribution information of the plurality of candidate answers. In addition, the method further comprises determining, based on the plurality of candidate answers and the distribution information of the plurality of candidate answers, an answer for the question.

In this way, the embodiments of the method can avoid the problem of context overload by condensing the original answers into distribution information, and enable the models to effectively handle a large number of responses. And the embodiments of the method also help enhance the model's decision-making basis, that is, when generating new predictions, the models can adjust their strategy based on the distribution characteristics of historical answers, rather than relying on isolated samples, thereby improving the robustness and accuracy of decision-making.

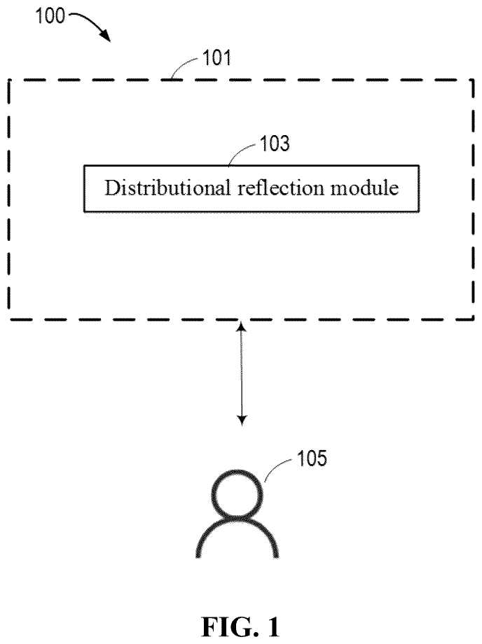

FIG. 1 shows an overall architecture and application scenario 100 in which one or more embodiments of the present disclosure may be implemented according to some embodiments of the present disclosure. The architecture 100 is totally different from the traditional overall architecture. The traditional overall architecture only uses one or more models for reasoning or training. In contrast, the architecture 100 may include a distributional reflection module 103 to improve model reasoning and training. The architecture 100 may include the machine learning model system 101, and the machine learning model system 101 may include one or more machine learning models. The user 105 may interact with the machine learning model system 101. And the user 105 may raise a question or provide a task for the machine learning model system 101 to provide an answer for the question from the user 105.

In FIG. 1, the distributional reflection module 103 may interact with the one or more models in the machine learning model system 101 to implement the method of distributional reflection to improve model reasoning and model training. The method comprises obtaining a plurality of candidate answers for a question. And the method further comprises determining, based on the plurality of candidate answers and a plurality of counts of the plurality of candidate answers, distribution information of the plurality of candidate answers. And the method further comprises determining, based on the plurality of candidate answers and the distribution information of the plurality of candidate answers, an answer for the question. In this way, the embodiments of the method can avoid the problem of context overload by condensing the original answers into distribution information, and enable the models to effectively handle a large number of responses. And the embodiments of the method also help enhance the models' decision-making basis, that is, when generating new predictions, the models can adjust their strategy based on the distribution characteristics of historical answers, rather than relying on isolated samples, thereby improving the robustness and accuracy of decision-making etc.

Next, multiple embodiments of the present disclosure will be described in detail with reference to the relevant drawings and based on the overall schematic flow chart and application scenario 100 according to one or more embodiments of the present disclosure.

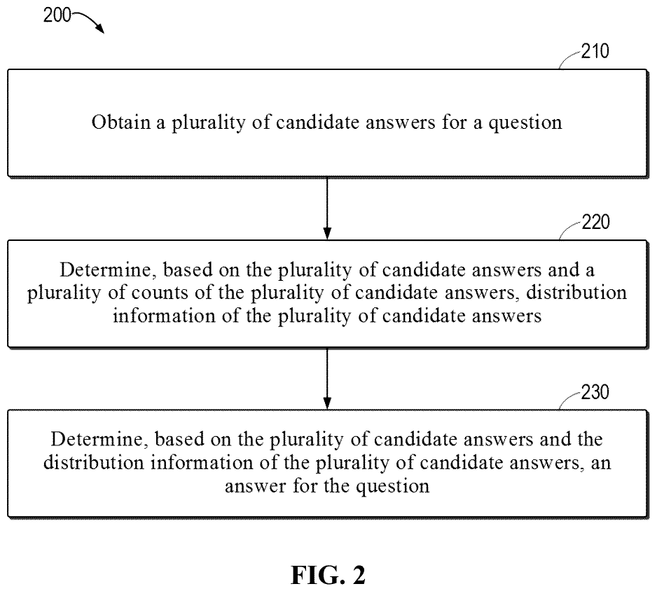

FIG. 2 is a flow chart illustrating an example process 200 for improving model reasoning according to some embodiments of the present disclosure. The example interaction process 200 may be implemented by a computing device, and may be implemented in the overall schematic flow chart and application scenario 100. The present disclosure does not specifically limit the specific implement of the process 200. Any suitable implement of process 200 for the present disclosure should be within the protection scope of the present disclosure. As shown in FIG. 2, at block 210, a plurality of candidate answers for a question may be obtained. In some embodiments, the method 200 may receive a question from the user 105. In some embodiments, the one or more models of the machine learning model system 101 may provide the plurality of candidate answers for the question based on the question. In some embodiments, obtaining the plurality of candidate answers for the question and distribution information of the plurality of candidate answers may comprise determining, by a first model and based on the question, the plurality of candidate answers and distribution information of the plurality of candidate answers for the question iteratively. In some embodiments, the first model may comprise a plurality of models.

At block 220, distribution information of the plurality of candidate answers is determined based on the plurality of candidate answers and a plurality of counts of the plurality of candidate answers. In some embodiments, the distribution information of the plurality of candidate answers comprises at least one of at least one common answer, at least one common incorrect answer, at least one sample of unique answers, frequency of answers, and answer variance.

At block 230, an answer for the question is determined based on the plurality of candidate answers and the distribution information of the plurality of candidate answers. In some embodiments, determining, based on the plurality of candidate answers and the distribution information of the plurality of candidate answers, the answer for the question may comprise determining, based on the plurality of candidate answers and the distribution information of the plurality of candidate answers, at least one common incorrect answer predicted by a first model, and determining, based on the plurality of candidate answers, the distribution information of the plurality of candidate answers and the at least one common incorrect answer predicted by the first model, the answer for the question.

In some embodiments, determining, based on the plurality of candidate answers, the distribution information of the plurality of candidate answers and the at least one common incorrect answer predicted by the first model, the answer for the question may comprise determining, based on the at least one common incorrect answer, the distribution information of the at least one common incorrect answer, and determining, based on the plurality of candidate answers, the distribution information of the plurality of candidate answers and the distribution information of the at least one common incorrect answer, the answer for the question. In some embodiments, determining, based on the plurality of candidate answers, the distribution information of the plurality of candidate answers and the distribution information of the at least one common incorrect answer, the answer for the question may comprise reducing, based on the distribution information of the plurality of candidate answers and the distribution information of the at least one common incorrect answer, at least one first weight of the at least one common incorrect answer for the answer for the question.

In some embodiments, determining, based on the plurality of candidate answers, the distribution information of the plurality of candidate answers and the distribution information of the at least one common incorrect answer, the answer for the question may comprise determining, based on the plurality of candidate answers, the distribution information of the plurality of candidate answers and the at least one reduced first weight of the at least one common incorrect answer, the answer for the question. In some embodiments, the answer for the question is an answer with a highest first weight among the plurality of candidate answers.

In some embodiments, reducing, based on the distribution information of the plurality of candidate answers and the distribution information of the at least one common incorrect answer, at least one first weight of the at least one common incorrect answer for the answer for the question may comprise reducing, based on the distribution information of the plurality of candidate answers, the distribution information of the at least one common incorrect answer and at least one second weight for the distribution information of the at least one common incorrect answer, the at least one first weight of the at least one common incorrect answer, wherein the at least one second weight controls the contribution of the at least one common incorrect answer for the answer for the question.

In some embodiments, the at least one second weight is determined based on at least one of the distribution information of the plurality of candidate answers, the distribution information of the at least one common incorrect answer, distribution information of ground-truth answers, and distribution information of at least one ground-truth common incorrect answer, wherein the distribution information of ground-truth answers is determined based on the distribution information of the plurality of candidate answers, and the distribution information of at least one ground-truth common incorrect answer is determined based on the distribution information of the at least one common incorrect answer.

In some embodiments, determining, based on the plurality of candidate answers and the distribution information of the plurality of candidate answers, the answer for the question may comprise determining, based on the plurality of candidate answers and the distribution information, a plurality of updated candidate answers and distribution information of the plurality of updated candidate answers, and determining, based on the plurality of updated candidate answers and the distribution information of the plurality of updated candidate answers, the answer for the question.

In some embodiments, the process 200 may comprise acquiring a plurality of training answers for the question, and training, based on the plurality of training answers, a first model by identifying at least one non-common incorrect new answer from the first model. In some embodiments, training, based on the plurality of training answers, the first model by identifying at least one non-common incorrect new answer from the first model may comprises in response the at least one non-common incorrect new answer being identified, rewarding a first reward value greater than zero for the at least one non-common incorrect answers.

In some embodiments, training, based on the plurality of training answers, the first model by identifying at least one non-common incorrect new answer from the first model further comprises at least one of in response to at least one correct new answer from the first model being identified, rewarding a second reward value for the at least one correct new answer, and in response to the at least one common incorrect new answer from the first model being identified, rewarding a third reward value for the at least one common incorrect new answer. In some embodiments, the second reward value equals 1, the first reward value is less than 1, and the third reward value equals zero.

In this way, the embodiments of the process 200 can avoid the problem of context overload by condensing the original answers into distribution information, and enable the models to effectively handle a large number of responses. And the embodiments of the process 200 also help enhance the models' decision-making basis, that is, when generating new predictions, the models can adjust their strategy based on the distribution characteristics of historical answers, rather than relying on isolated samples, thereby improving the robustness and accuracy of decision-making. Furthermore, the embodiments of the process 200 support scalable sample utilization, by compressing redundant information, the embodiments of the process 200 allow the models to integrate more historical data during training or inference without increasing context length, making it suitable for scenarios requiring multi-round interactions or large-scale sample analysis.

Furthermore, the embodiments of the process 200 provide the mechanism of distributional reflection, a refinement paradigm in which self-reflection is conditioned on the distribution of previously sampled candidates, rather than on a single prior response. Distributional reflection prevents self-reinforcing errors by allowing the model to reason about rare answers nearly as much as more common ones. This capability is especially important in the presence of error concentration, where most probability mass is assigned to a small set of distinct but incorrect answers. In such settings, conventional self-reflection often fails, as refinement steps amplify the same error rather than correcting it.

Furthermore, the embodiments of the process 200 also provide an inference-time mechanism of anti-votes, in which the one or more models explicitly predict likely incorrect answers. Anti-votes enable direct down-weighting of dominant errors during aggregation, further mitigating error concentration. The embodiments of the process 200 identify sufficient conditions under which anti-votes strictly improve majority-vote accuracy, and confirm empirically that they yield consistent gains in practice. Moreover, the embodiments of the process 200 provide a theoretical guideline on how to optimally weight anti-votes with the original votes.

Furthermore, the embodiments of the process 200 also introduce a theoretically grounded training objective, the diverse failure reward, which encourages calibrated and diverse errors while preserving single-sample accuracy. And optimizing this reward directly improves expected majority-vote accuracy, both in the zero-shot setting and when combined with iterative refinement, by reducing the dominance of correlated failures.

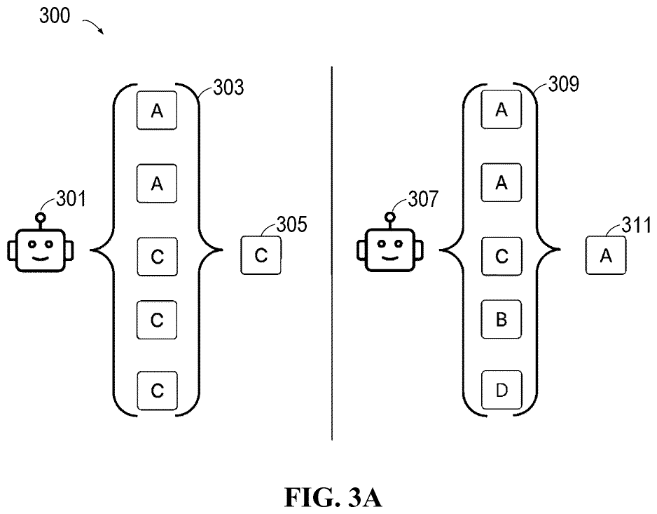

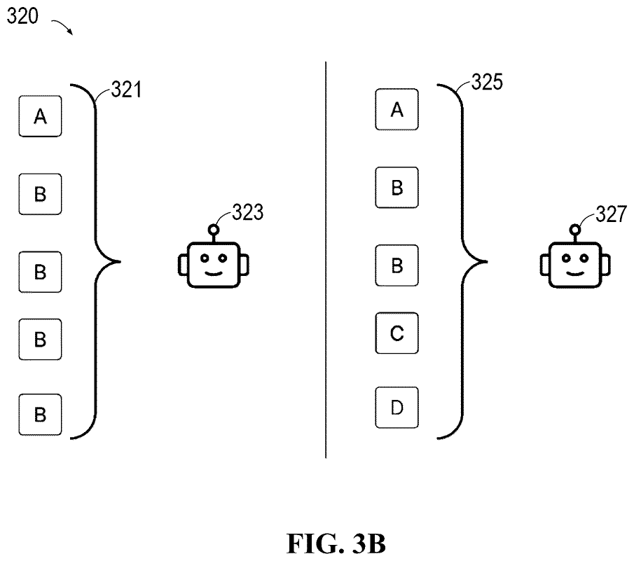

In order to help those skilled in the art better understand the embodiments of the present disclosure, the basic ideas of the embodiments of the present disclosure will be explained in detail below with reference to FIGS. 3A and 3B. FIGS. 3A and 3B show a schematic comparison of processing concentrated errors and diverse errors and how error diversity affects inference-time scaling according to embodiments of this disclosure. FIG. 3A shows the processing method 300 based on the traditional majority vote, and FIG. 3B shows the schematic processing method 313 based on the embodiments of the present disclosure.

In FIG. 3A, if many samples 303 (with the set of answers A, C etc.) and 309 (with the set of answers A, B, C and D etc.) etc. repeat the same mistake (e.g., the error answer C 305 or the error answer A 311), majority vote by the models 301 or 307 can select that shared error (e.g., the error answer C 305 or the error answer A 311), and refinement can become biased toward it if not properly guided towards exploring lower density alternative solutions. Such behavior is not a corner case and was observed widely. That is, when errors are concentrated, majority vote selects an incorrect answer. In many settings, model errors are indeed highly concentrated and frequency often becomes a proxy for correctness during inference, leading to diminishing returns from additional sampling. This perspective suggests that correctness alone is an insufficient training target when the goal is to improve inference-time aggregation, such as majority vote or iterative refinement. What matters is not only whether an individual sample is correct, but how errors are distributed across samples when the model is wrong. Majority vote is most effective when the correct answer is stable and incorrect answers are dispersed. Similarly, iterative refinement benefits when trajectories continue to explore alternative hypotheses, rather than collapsing early onto a single incorrect solution that dominates subsequent updates. These observations point to a common underlying objective to pursue, that is, shaping the error distribution induced by the model's policy.

In FIG. 3B, when errors are concentrated (e.g., the answer B) in the sample 321 including the set of answers A and B etc., the model 323 will have a narrow solution space to select. When errors are diverse (e.g., the answer D) in the sample 325 including the set of answers A, B, C and D etc., incorrect vote mass is dispersed and the correct answer is more likely to prevail for the model 327. The key intuition is that while there are only a few ways to solve a problem correctly, there are many ways to make mistakes. Greater error diversity also encourages solution space exploration without sacrificing the correctness. This can be especially helpful when one of the minority answers is the correct answer.

Furthermore, in order to help those skilled in the art better understand the embodiments of the present disclosure, two widely used tools related to the embodiments of the present disclosure are introduced as below. One is the tool of majority vote, which aggregates several sampled answers into one prediction, and the other tool is iterative refinement, where the model updates its answer after seeing additional context. The success of these two tools depends on a factor that is easy to overlook, namely the distribution of errors across samples. The mathematical models of these two tools will be described in detail below. It is important to note that the mathematical models of the various embodiments of the present disclosure are merely exemplary and not intended to limit the scope of protection of the present disclosure. Any mathematical model suitable for this disclosure and its variations should be within the scope of protection of this disclosure.

Consider a task instance x with m possible answers. A policy π_{θ} generates a textual response o~π_{θ}(⋅|x), from which a discrete answer Z is extracted as formula (1):

$$Z := ans ( o ) ∈ [ m ] := \{ 1 , … , m \} \qquad ( 1 )$$

Let y∈[m] be the correct answer.

As for the tool of majority vote aggregation, given n independent sampled textual responses oᵢ, . . . , oₙ~π_{θ}(⋅|x) with answers Zᵢ:=ans(oᵢ), let \vec{N}=(N₁, . . . , Nₘ) denote the vote counts, where Nⱼ is the number of times answer j appears and

$${\sum }_{j}^{m} {N}_{j} = n .$$

The majority-vote outcome is as formula (2):

$${Z}_{msj} := arg {max}_{j ∈ [ m ]} {N}_{j} \qquad ( 2 )$$

As for the tool of iterative refinement, consider a T-step refinement process, at round t+1, the policy conditions on the task x and a refinement context C^{(t)} derived from previous outputs shown as formula (3):

$$\begin{matrix}{o}_{i}^{( t + 1 )} \sim {π}_{θ} ( \cdot \vert x , {C}^{( t )} ) , & t ∈ [ T ] , and i ∈ [ n ]\end{matrix} \qquad ( 3 )$$

with C^{(t)} empty, at each round, an answer

$${Z}_{i}^{( t )} := ans ( {o}_{i}^{( t )} )$$

is extracted, and aggregation may be applied to samples from the final round. The refinement context is method-specific and defined in subsequent sections.

Furthermore, in order to help those skilled in the art better understand the embodiments of the present disclosure related to the method of distributional reflection, the mathematical model of distributional reflection will be described in detail below. It is important to note that the mathematical models of the various embodiments of the present disclosure are merely exemplary and not intended to limit the scope of protection of the present disclosure. Any mathematical model suitable for this disclosure and its variations should be within the scope of protection of this disclosure. In some embodiments, the distributional reflection is an inference-time refinement paradigm that conditions update on the distribution of previously sampled solutions.

Generally, standard self-refinement methods condition each update on a single previous response or its critique. While effective in some settings, this approach can fail when the model repeatedly produces the same incorrect answer, causing refinement trajectories to collapse. To address this limitation, the present disclosure introduces distributional reflection, which conditions update on the distribution of solutions produced by the model. Let \tilde{p}^{(t)}∈Δ^{m} denote the empirical distribution of the answers

$${{Z}_{i}^{( t )}}_{i = 1}^{n}$$

at round t≥1, where Δ^{m} denotes the m-dimensional

$${\tilde{p}}_{j}^{( t )} := \frac{1}{n} {\sum }_{i = 1}^{n} 1 \{ {Z}_{i}^{( t )} = j \} \qquad ( 4 )$$

Distributional reflection generates a new response by conditioning on this empirical answer distribution as formula (5):

$${o}_{i}^{( t + 1 )} ∼ {π}_{θ} ( \cdot \vert x , {\tilde{p}}^{( t )} ) , {Z}_{i}^{( t + 1 )} := ans ( {o}_{i}^{( t + 1 )} ) \qquad ( 5 )$$

This allows the model to reason about which answers are common, which are rare, and how concentrated its uncertainty is, rather than reacting only to a single prior attempt.

In practice, the distribution \tilde{p}^{(l)} is summarized into a compact context

$${C}_{dist}^{( t )} ( x ) .$$

In some embodiments, this context may consist of the empirical distribution over answer choices (for example, the number of times each option is selected), along with one representative full response for each answer choice.

In some embodiments, like multi-agent debate, distributional reflection exposes a model to multiple solutions. However, debate conditions on a small set of individual responses (typically from different models), without encoding their relative frequency or dominance, and thus does not reflect the underlying solution distribution. In contrast, distributional reflection conditions explicitly on an approximation of the model's own prior distribution, making errors and uncertainty directly visible.

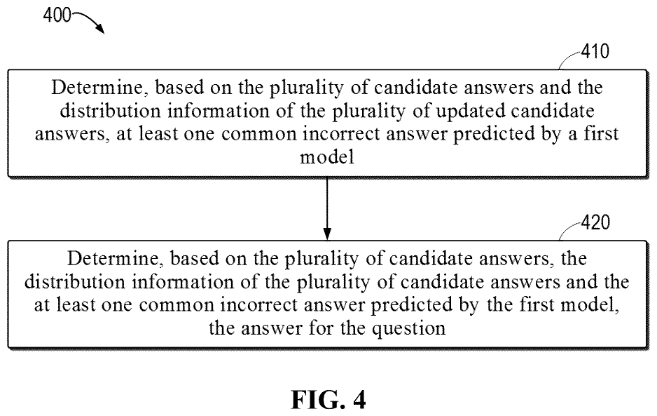

FIG. 4 is a flow chart illustrating an example process 400 for anti-votes according to some embodiments of the present disclosure. At block 410, at least one common incorrect answer predicted by a first model is determined based on the plurality of candidate answers and the distribution information of the plurality of candidate answers. In some embodiments, the distribution information of the plurality of candidate answers comprises at least one of at least one common answer, at least one common incorrect answer, at least one sample of unique answers, frequency of answers, and answer variance.

At block 420, the answer for the question is determined based on the plurality of candidate answers, the distribution information of the plurality of candidate answers and the at least one common incorrect answer predicted by the first model. In some embodiments, determining, based on the plurality of candidate answers, the distribution information of the plurality of candidate answers and the at least one common incorrect answer predicted by the first model, the answer for the question may comprise determining, based on the at least one common incorrect answer, the distribution information of the at least one common incorrect answer, and determining, based on the plurality of candidate answers, the distribution information of the plurality of candidate answers and the distribution information of the at least one common incorrect answer, the answer for the question.

In some embodiments, determining, based on the plurality of candidate answers, the distribution information of the plurality of candidate answers and the distribution information of the at least one common incorrect answer, the answer for the question may comprise reducing, based on the distribution information of the plurality of candidate answers and the distribution information of the at least one common incorrect answer, at least one first weight of the at least one common incorrect answer for the answer for the question.

In some embodiments, determining, based on the plurality of candidate answers, the distribution information of the plurality of candidate answers and the distribution information of the at least one common incorrect answer, the answer for the question may comprise determining, based on the plurality of candidate answers, the distribution information of the plurality of candidate answers and the at least one reduced first weight of the at least one common incorrect answer, the answer for the question. In some embodiments, the answer for the question is an answer with a highest first weight among the plurality of candidate answers.

In some embodiments, reducing, based on the distribution information of the plurality of candidate answers and the distribution information of the at least one common incorrect answer, at least one first weight of the at least one common incorrect answer for the answer for the question may comprise reducing, based on the distribution information of the plurality of candidate answers, the distribution information of the at least one common incorrect answer and at least one second weight for the distribution information of the at least one common incorrect answer, the at least one first weight of the at least one common incorrect answer, wherein the at least one second weight controls the contribution of the at least one common incorrect answer for the answer for the question.

In some embodiments, the at least one second weight is determined based on at least one of the distribution information of the plurality of candidate answers, the distribution information of the at least one common incorrect answer, distribution information of ground-truth answers, and distribution information of at least one ground-truth common incorrect answer, wherein the distribution information of ground-truth answers is determined based on the distribution information of the plurality of candidate answers, and the distribution information of at least one ground-truth common incorrect answer is determined based on the distribution information of the at least one common incorrect answer.

In some embodiments, determining, based on the plurality of candidate answers and the distribution information of the plurality of candidate answers, the answer for the question may comprise determining, based on the plurality of candidate answers and the distribution information, a plurality of updated candidate answers and distribution information of the plurality of updated candidate answers, and determining, based on the plurality of updated candidate answers and the distribution information of the plurality of updated candidate answers, the answer for the question.

In this way, the embodiments of the process 400 provide an inference-time mechanism of anti-votes, in which the one or more models explicitly predict likely incorrect answers. Anti-votes enable direct down-weighting of dominant errors during aggregation, further mitigating error concentration. The embodiments of the process 400 identify sufficient conditions under which anti-votes strictly improve majority-vote accuracy, and confirm empirically that they yield consistent gains in practice. Moreover, the embodiments of the process 400 provide a theoretical guideline on how to optimally weight anti-votes with the original votes.

Furthermore, in order to help those skilled in the art better understand the embodiments of the present disclosure related to the method of anti-votes, the mathematical model of anti-votes will be described in detail below. It is important to note that the mathematical models of the various embodiments of the present disclosure are merely exemplary and not intended to limit the scope of protection of the present disclosure. Any mathematical model suitable for this disclosure and its variations should be within the scope of protection of this disclosure. In some embodiments, the distributional reflection is an inference-time refinement paradigm that conditions update on the distribution of previously sampled solutions.

Before introducing the mathematical model of anti-votes, two concepts of error concentration and diverse failure reward need to be explained in detail as below. As for error concentration, a key challenge for both majority vote and distributional reflection is error concentration. When a model is incorrect, it often assigns most probability mass to a small number of distinct wrong answers. In this regime, the majority vote tends to select the common mistake, and refinement may reinforce it. The empirical majority answer \tilde{Z}ₑᵣᵣ may be defined as (omitting the round number)

$${\tilde{Z}}_{err} := arg {max}_{i ∈ [ m ] \backslash \{ u \}} {\tilde{p}}_{j} ,$$

with ties broken uniformly at random. If all samples are correct, \tilde{Z}ₑᵣᵣ is undefined. The goal is to reduce error concentration by shaping the distribution of incorrect answers while preserving average correctness.

As for diverse failure reward, an implicit mechanism for shaping error distributions via training may be first introduced. For a sampled answer Z, diverse failure reward may be defined as formula (6):

$${r}_{D - FUSEr} ( Z ; y , {\tilde{Z}}_{err} ) := 1 \{ Z ∉ \{ y , {\tilde{Z}}_{err} \} \} \cdot 1 \{ {\tilde{Z}}_{err} is defined \} \qquad ( 6 )$$

Intuitively, when the model is wrong, it is rewarded for being wrong in a way that differs from the most common incorrect answer. The total reward is given by formula (7):

$$R ( Z ; y , {\tilde{Z}}_{err} ) := {r}_{corr} ( Z ; y ) + 1 / 2 {r}_{D - FUSEr} ( Z ; y , {\tilde{Z}}_{err} ) \qquad ( 7 )$$

where r_{corr}(Z:y):=1{Z=y}, and y is the correct answer. In some embodiments, optimizing the expected D-FUSEr reward improves expected majority-vote accuracy and reduces collapse during refinement. Therefore, the reward design can be used with any reward-based training method. And the experiments show strong performance.

As for the anti-votes, while the reward shapes errors implicitly through training, anti-votes provide an explicit inference-time mechanism for down-weighting shared mistakes. In addition to an answer, each sampled response may include an anti-vote Aᵢ∈[m], indicating a prediction of the common mistake. Given n samples, the empirical anti-vote distribution may be defined as formula (8):

$${\tilde{q}}_{j} := \frac{1}{n} {\sum }_{i = 1}^{n} 1 \{ {A}_{i} = j \} \qquad ( 8 )$$

Note that anti-votes are also compatible with iterative refinement, while the superscript t is omitted here for simplicity. then a reweighted score may be computed as formula (9):

$${S}_{j} := {\tilde{p}}_{j} - η {\tilde{q}}_{j} \qquad ( 9 )$$

Where the weight η≥0 controls the strength of the anti-vote contribution. The final prediction is given by Zₐₙₜᵢ₋ₘₐⱼ:=^{arg maxj∈[m]S}^{ⱼ}.

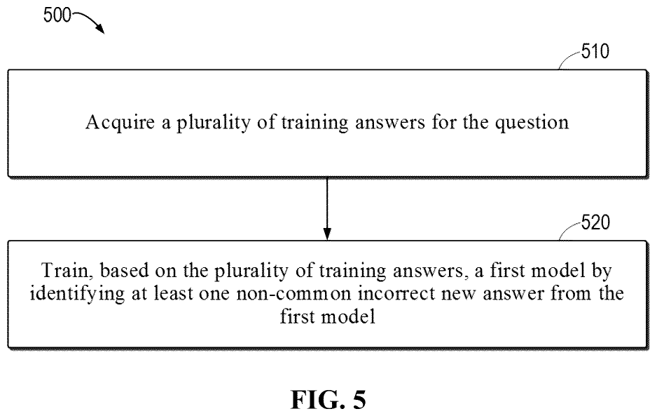

FIG. 5 is a flow chart illustrating an example process 500 for training a model according to some embodiments of the present disclosure. At block 510, a plurality of training answers for the question is acquired. In some embodiments, the plurality of training answers may be generated by sampling responses using off-the-shelf models. The target model to be trained is tasked with generating a refined response conditioned on the distribution of these responses. In some embodiments, the distribution information of the plurality of training answers may be obtained.

At block 520, a first model is trained based on the plurality of training answers and by identifying at least one non-common incorrect new answer from the first model. In some embodiments, the first model is trained based on the plurality of training answers and the distribution information of the plurality of training answers, and by identifying at least one non-common incorrect new answer from the first model.

In some embodiments, training, based on the plurality of training answers, the first model by identifying at least one non-common incorrect new answer from the first model may comprises in response the at least one non-common incorrect new answer being identified, rewarding a first reward value greater than zero for the at least one non-common incorrect answers.

In some embodiments, training, based on the plurality of training answers, the first model by identifying at least one non-common incorrect new answer from the first model further comprises at least one of in response to at least one correct new answer from the first model being identified, rewarding a second reward value for the at least one correct new answer, and in response to the at least one common incorrect new answer from the first model being identified, rewarding a third reward value for the at least one common incorrect new answer. In some embodiments, the second reward value equals 1, the first reward value is less than 1, and the third reward value equals zero.

In this way, the embodiments of the process 500 introduce a theoretically grounded training objective, the diverse failure reward, which encourages calibrated and diverse errors while preserving single-sample accuracy. And optimizing this reward directly improves expected majority-vote accuracy, both in the zero-shot setting and when combined with iterative refinement, by reducing the dominance of correlated failures.

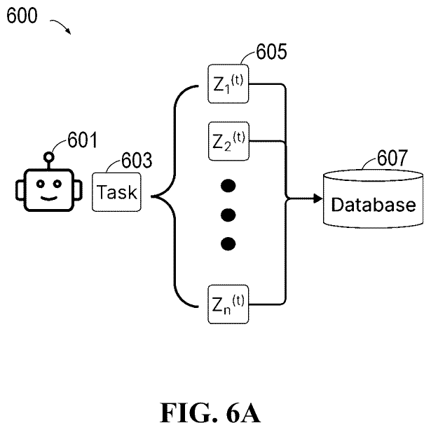

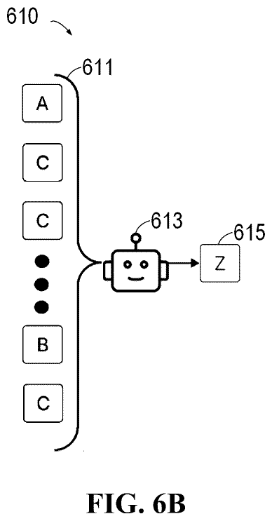

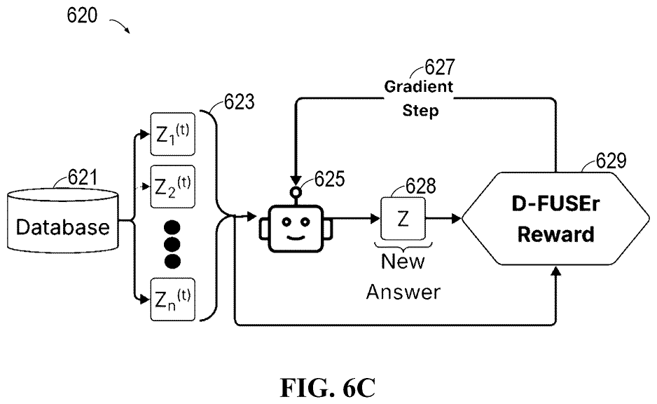

In order to help those skilled in the art better understand the embodiments of the present disclosure, the training process of the embodiments of the present disclosure will be explained in detail below with reference to FIGS. 6A, 6B and 6C. FIGS. 6A, 6B and 6C show a schematic outline of D-FUSEr training framework according to embodiments of this disclosure. FIG. 6A shows the data collection process 600 according to the embodiments of the present disclosure, FIG. 6B shows the D-FUSEr Reward process 610 according to the embodiments of the present disclosure, and FIG. 6C shows the model training process 620 according to the embodiments of the present disclosure.

In FIG. 6A, the user may input a task 603 or raise a question, and the one or more models 601 may obtain the task 603 or the question as the input of the one or more models 601. And the one or more models 601 may generate a set of answers 605 which includes answers

$${{Z}_{i}^{( t )}}_{i = 1}^{n} .$$

In some embodiments, the set of answers 605 may be stored in the database 607 etc. as training data. In some embodiments, the training data may be generated by sampling responses using off-the-shelf models. The target model is tasked with generating a refined response conditioned on the distribution of these responses.

In FIG. 6B, the training data 611 including the answers A, B and C etc. may be input into the target model 613 to training the target model 613. And the new answer 615 (e.g, a new answer z) may be rewarded with a D-FUSEr Reward. In some embodiments, the reward function may consist of the correctness reward, and failure reward. The failure reward is applied only when the model's answer is incorrect, and differs from the most common incorrect answer in the previous round. In some embodiments, in response the at least one non-common incorrect new answer being identified, a first reward value greater than zero and less than 1 may be rewarded for the at least one non-common incorrect answers. In some embodiments, the first reward value may be 0.5.

In some embodiments, in response to at least one correct new answer from the model 613 being identified, a second reward value may be rewarded for the at least one correct new answer. In some embodiments, the second reward value may be greater than the first reward value. In some embodiments, the second reward value may equal 1. In some embodiments, in response to the at least one common incorrect new answer from the first model being identified, rewarding a third reward value for the at least one common incorrect new answer. In some embodiments, the third reward value equals zero.

In FIG. 6C, with the collected data 623 stored in the database 621 and the defined reward function, any reinforcement learning framework can be applied to train the one or more models 625. In some embodiments, the new answer 628 (e.g., an answer z) may be generated by the one or more models 625. In some embodiments, the D-FUSEr Reward may be rewarded for the new answer 628. In some embodiments, the new answer 628 with the D-FUSEr Reward 629 may be fed back to the one or more models 625 through the gradient step 627 for further training. In some embodiments, the method of anti-votes may be introduced into the training process 620, in which the one or more models predicts at least one common incorrect answer or the most likely incorrect answer alongside its solution.

In this way, the embodiments of the processes 600, 610 and 620 introduce a theoretically grounded training objective, the diverse failure reward, which encourages calibrated and diverse errors while preserving single-sample accuracy. And optimizing this reward directly improves expected majority-vote accuracy, both in the zero-shot setting and when combined with iterative refinement, by reducing the dominance of correlated failures.

Furthermore, in order to help those skilled in the art better understand the embodiments of the present disclosure, the mathematical model of theories of the embodiments of the present disclosure will be described in detail below. It is important to note that the mathematical models of theories of the various embodiments of the present disclosure are merely exemplary and not intended to limit the scope of protection of the present disclosure. Any mathematical model suitable for this disclosure and its variations should be within the scope of protection of this disclosure. In some embodiments, the distributional reflection is an inference-time refinement paradigm that conditions update on the distribution of previously sampled solutions.

In some embodiments, a set of theoretical results/guarantees for the methods of the present disclosure will be explained in detail. When one error distribution yields higher majority-vote accuracy than another, then the reward r_{D-FUSEr} steers errors in this direction. Sufficient conditions may be gived under which this guarantee extends to iterative refinement, and conclude by discussing when anti-votes are strictly beneficial and what properties of an anti-vote distribution are preferred.

Firstly, some global notations will be introduced. Given two Large Language Model (LLM) answer distributions p and p′, suppose without loss of generality that the correct answer is y=1 and pⱼ, p′ⱼ>0 for any j∈[m]. Let e=(p₂, . . . , pₘ)/(1−p₁) and e′=(p′₂, . . . , p′ₘ)/(1−p′₁) be the error distributions. Let Acc_{MV}(p; n) be the majority-vote accuracy with n i.i.d. (independent and identically distributed)/samples from distribution n.

In some embodiments, a definition of majority-vote accuracy and a definition of error entropy will be explained as below. As for the definition of majority-vote accuracy, let v, v′∈ [symbol] be two vectors, and let v^{l} and v′^{l} denote the vectors obtained by sorting the entries of v and v′ in non-increasing order. Then, v weakly majorizes v′, i.e.,

$${\sum }_{i}^{k} {v}_{i}^{↓} \geq {\sum }_{i}^{k} {v}_{i}^{′ ↓}$$

for any k∈[m]. Moreover, v strictly majorizes v′, i.e., v>v′, if the above inequality is strict for at least one k. As for the definition of error entropy, given an error distribution e has a higher error entropy than e′ if e≥e′.

In some embodiments, higher error entropy may lead to lower majority-vote accuracy. Given two answer distributions p, p′∈Δ^{m} with p₁=p′₁ ∈(0, 1), if e′≥e, then Acc^{MV}(p; n)≥Acc^{MV}(p; n) for n≥1.

In this way, the error distribution e∈Δ^{m-1} of an optimal policy may be precisely characterized. Thus, a corollary 1 may be obtained as uniform error maximizes majority accuracy. For example, fixing p₁, the uniform error distribution maximizes the majority-vote accuracy. Next the error entropy may be connected to the reward r_{D-FUSEr}.

In some embodiments, the error entropy may be related to the proposed reward function. Consider an LLM with answer distribution p∈Δ^{m}. The reward function draws n̅i.i.d./ reference samples fromp to identify the majority mistake Zₑᵣᵣ ∈[m]\{y}, with uniform tie-breaking. Given a new answer Z~p, the total reward is

$$R ( Z ; y , {Z}_{err} ) = 𝕀 [ Z = y ] + \frac{1}{2} \cdot 𝕀 \{ Z \neq {Z}_{err} \} .$$

The expected reward may be denoted as formula (10):

$$R ( p ; \overline{n} ) = {𝔼}_{Z , {Z}_{err}} [ R ( Z ; y , {Z}_{err} ) ] \qquad ( 10 )$$

A higher expected reward R(p:n̅) corresponds to a higher majority-vote, accuracy, and conversely. First, conditioned on the same accuracy, the uniform error minimizes the expected reward.

In some embodiments, a theorem 1 may be that uniform error maximizes expected D-FUSEr reward. Given an answer distribution p∈Δ^{m} with a fixed accuracy p₁, for any n̅≥2, the expected reward R(p;n̅) is maximized if and only if e is uniform. Putting the corollary 1 and the theorem 1 together, among distributions with the same accuracy, expected reward and majority-vote accuracy share the same maximizer, which is the uniform error distribution. Next showing that when m=3, higher expected reward implies higher majority-vote accuracy, and vice versa, i.e., optimizing r_{D-FUsEr} optimizes majority vote accuracy. Then a theorem 2 of D-FUSEr Reward-Majority Accuracy Equivalence may be introduced. Given an answer distribution p∈Δ³ with a fixed accuracy p₁, the majority-vote accuracy Acc^{MV}(p; n) strictly increases in R(p;n̅) for n̅≥2, and vice versa.

As for iterative refinement, a setting may be studied where an LLM iteratively refines its beliefs over multiple rounds, which can be molded by a transition function γ. The model observes a sample of n solutions in round t, and updates is solution distribution via p^{(t+1)}=γ(p^{(t)},\vec{N}^{(t)})∈Δ^{m}, where \vec{N}^{(t)} is the vote-count vector. Next, conditions may be identified under which a lower error entropy leads to higher majority-vote accuracy over successive inference rounds.

In some embodiments, a definition of Monotone Updating Rule (Informal) may be introduced. An updating rule γ is monotone if it preserves order in both error entropy and accuracy in expectation. In some embodiments, LLM updating is indeed monotone. The following theorem shows that higher error entropy (i.e., higher D-FUSEr reward) leads to higher next-round majority-vote accuracy under any monotone updating rule. Since the result applies to an arbitrary round t, the superscript of t may be suppressed. In some embodiments, a theorem 3 may be that higher D-FUSEr reward increases next-round majority accuracy. For example, suppose m=3, let p, p′∈Δ³ be two answer distributions such that p₁=p′₁ and R(p;n̅)≥R(p′;n̅) for an n≥2. If the updating rule γ is monotone, then the majority accuracy of n≥1 i.i.d. votes drawn from γ(p,\vec{N}) is weakly higher than that under γ(p′,\vec{N}′) where \vec{N} and \vec{N}′ are the vote counts from p and p′ respectively.

As for the anti-votes, the anti-votes provide an inference-time mechanism for diversifying concentrated mistakes. When anti-votes are beneficial and what anti-vote distribution is desired will be explained as below. For ease of analysis, an anti-vote for answer j does not directly penalize j, instead, it redistributes mass to the remaining answers via a convex combination with parameter α, enabling a simpler characterization in terms of the mixed distribution

$$r ( α ) = α p + ( 1 - α ) \frac{1 - q}{m - 1} ∈ {Δ}^{m} .$$

In somie embodiments, a proposition of when anti-votes help may be introduced. Suppose m=3 and the answer distribution is p=(p₁, p₂, p₃)∈Δ³ with p₁>p₃. If q₁≤1−2p₁ and q₂≥q₃, there exists an α<1 such that R(r(α);n̅)>R(r(1);n̅) for any n̅≥2 and Acc^{MV}(r(α); n)>Acc^{MV} (r(1); n) for any n≥3. The proposition of when anti-votes provides a sufficient condition under which incorporating anti-votes strictly improves performance over using votes alone. Intuitively, the requirement q₁≤1−2p₁ ensures that the anti-vote predictor does not place excessive mass on the correct answer, while q₂≥q₃ means that it more reliably targets the common mistake rather than the rarer one. In some embodiments, the anti-votes that better predict the common mistake are always preferred and whenever a strict benefit is attainable even in regimes in which anti-votes are not accurate enough to guarantee a strict improvement.

As for the the Optimal Weight η, a theoretical guideline of how to select the optimal η in the original implementation described above will be explained in detail as below. Aggregation with weight q selects the answer maximizing \tilde{p}ⱼ−η\tilde{q}ⱼ, where \tilde{p} and \tilde{q} are the empirical distributions estimated by a finite number of samples. In the large-sample regime, correct aggregation requires that the ground-truth label y be separated from all incorrect answers along this direction. This leads to the following analytical guideline as formula (11):

$${η}^{★} \approx arg {max}_{η} {min}_{j \neq y} \{ ( {\tilde{p}}_{y} - {\tilde{p}}_{j} ) - η ( {\tilde{q}}_{y} - {\tilde{q}}_{j} ) \} = {max}_{j \neq y} \frac{{\tilde{p}}_{j} - {\tilde{p}}_{y}}{{\tilde{q}}_{j} - {\tilde{q}}_{y}} \qquad ( 11 )$$

where the maximization ranges over competitors with qⱼ>q_{y}. Intuitively, η should be chosen just large enough so that the most dangerous incorrect answer (one with both high answer probability and low anti-vote probability) is down-weighted relative toy. This choice maximizes the worst-case margin between y and all competing answers, balancing answer accuracy against anti-vote information.

To sum up, the embodiments of the present disclosure propose the D-FUSEr framework for improving inference-time scaling by explicitly controlling how errors are distributed across samples. The starting point of the D-FUSEr framework is distributional reflection, a refinement paradigm in which self-reflection is conditioned on the distribution of previously sampled candidates, rather than on a single prior response. Distributional reflection prevents self-reinforcing errors by allowing the model to reason about rare answers nearly as much as more common ones. This capability is especially important in the presence of error concentration, where most probability mass is assigned to a small set of distinct but incorrect answers. In such settings, conventional self-reflection often fails, as refinement steps amplify the same error rather than correcting it.

Building on this perspective, the D-FUSEr framework further provides two complementary mechanisms for making effective use of distributional reflection. First, a theoretically grounded training objective, the diverse failure reward r_{D-FUSEr} is introduced, which encourages calibrated and diverse errors while preserving single-sample accuracy. Optimizing this reward directly improves expected majority-vote accuracy, both in the zero-shot setting and when combined with iterative refinement, by reducing the dominance of correlated failures.

Second, the D-FUSEr framework further proposes the anti-votes, an inference-time mechanism in which the model explicitly predicts likely incorrect answers. The Anti-votes enable direct down-weighting of dominant errors during aggregation, further mitigating error concentration. The D-FUSEr framework identifies sufficient conditions under which anti-votes strictly improve majority-vote accuracy, and confirm empirically that they yield consistent gains in practice. Moreover, the D-FUSEr framework also provides a theoretical guideline on how to optimally weight anti-votes with the original votes.

In this way, the embodiments of the present disclosure can avoid the problem of context overload by condensing the original answers into distribution information, and enable the models to effectively handle a large number of responses. And the embodiments of the present disclosure also help enhance the models' decision-making basis, that is, when generating new predictions, the models can adjust their strategy based on the distribution characteristics of historical answers, rather than relying on isolated samples, thereby improving the robustness and accuracy of decision-making. Furthermore, the embodiments of the present disclosure support scalable sample utilization, by compressing redundant information, the embodiments of the present disclosure allow the models to integrate more historical data during training or inference without increasing context length, making it suitable for scenarios requiring multi-round interactions or large-scale sample analysis.

Furthermore, the embodiments of the present disclosure provide the mechanism of distributional reflection, a refinement paradigm in which self-reflection is conditioned on the distribution of previously sampled candidates, rather than on a single prior response. Distributional reflection prevents self-reinforcing errors by allowing the model to reason about rare answers nearly as much as more common ones. This capability is especially important in the presence of error concentration, where most probability mass is assigned to a small set of distinct but incorrect answers. In such settings, conventional self-reflection often fails, as refinement steps amplify the same error rather than correcting it.

Furthermore, the embodiments of the present disclosure also provide an inference-time mechanism of anti-votes, in which the one or more models explicitly predict likely incorrect answers. Anti-votes enable direct down-weighting of dominant errors during aggregation, further mitigating error concentration. The embodiments of the present disclosure identify sufficient conditions under which anti-votes strictly improve majority-vote accuracy, and confirm empirically that they yield consistent gains in practice. Moreover, the embodiments of the present disclosure provide a theoretical guideline on how to optimally weight anti-votes with the original votes.

Furthermore, the embodiments of the present disclosure also introduce a theoretically grounded training objective, the diverse failure reward, which encourages calibrated and diverse errors while preserving single-sample accuracy. And optimizing this reward directly improves expected majority-vote accuracy, both in the zero-shot setting and when combined with iterative refinement, by reducing the dominance of correlated failures.

Embodiments of the present disclosure also provide an electronic device. The electronic device may comprise a memory and one or more processors, wherein the memory is configured to store one or more computer instructions which, when executed by the one or more processors, cause the one or more processors to obtain a plurality of candidate answers for a question. And the one or more computer instructions may further cause the one or more processors to determine, based on the plurality of candidate answers and a plurality of counts of the plurality of candidate answers, distribution information of the plurality of candidate answers. In addition, the one or more computer instructions may further cause the one or more processors to determine, based on the plurality of candidate answers and the distribution information of the plurality of candidate answers, an answer for the question.

In this way, the embodiments of the electronic device can avoid the problem of context overload by condensing the original answers into distribution information, and enable the models to effectively handle a large number of responses. And the embodiments of the electronic device also help enhance the models' decision-making basis, that is, when generating new predictions, the models can adjust their strategy based on the distribution characteristics of historical answers, rather than relying on isolated samples, thereby improving the robustness and accuracy of decision-making etc.

Embodiments of the present disclosure further provide a non-transitory computer-readable medium. The non-transitory computer-readable medium may comprise instructions stored thereon which, when executed by one or more processors, cause the one or more processors to obtain a plurality of candidate answers for a question. And the instructions may further cause the one or more processors to determine, based on the plurality of candidate answers and a plurality of counts of the plurality of candidate answers, distribution information of the plurality of candidate answers. In addition, the instructions may further cause the one or more processors to determine, based on the plurality of candidate answers and the distribution information of the plurality of candidate answers, an answer for the question.

In this way, the embodiments of the non-transitory computer-readable medium can avoid the problem of context overload by condensing the original answers into distribution information, and enable the models to effectively handle a large number of responses. And the embodiments of the non-transitory computer-readable medium also help enhance the models' decision-making basis, that is, when generating new predictions, the models can adjust their strategy based on the distribution characteristics of historical answers, rather than relying on isolated samples, thereby improving the robustness and accuracy of decision-making etc.

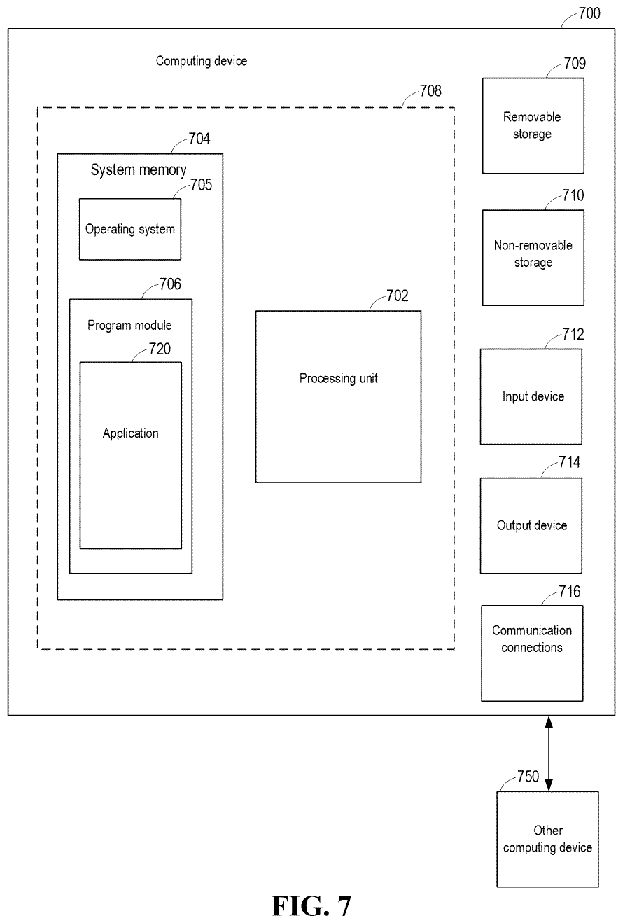

FIG. 7 is a block diagram illustrating physical components (e.g., hardware) of an electronic device 700 with which aspects of the disclosure may be practiced. For example, the electronic device 700 may implements the processes as depicted in FIG. 2 etc. In a basic configuration, the processing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for performing the various aspects disclosed herein such. The operating system 705, for example, may be suitable for controlling the operation of the processing device 700. Furthermore, aspects of the disclosure may be practiced in conjunction with other operating systems, or any other application program and is not limited to any particular application or system. This basic configuration is illustrated in FIG. 7 by those components within a dashed line 708. The processing device 700 may have additional features or functionality. For example, the processing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, several program modules and data files may be stored in the system memory 704. While executing on the at least one processing unit 702, an application 720 or program modules 706 may perform processes including, but not limited to, one or more aspects, as described herein. The application 720 may include an application interface 721 which may be the same as or similar to the application interface 721 as previously described in more detail with regard to FIG. 2 etc. Other program modules that may be used in accordance with aspects of the present disclosure may include electronic mail and contacts applications, word processing applications, spreadsheet applications, database applications, slide presentation applications, drawing or computer-aided application programs, etc., and/or one or more components supported by the systems described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the processing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general-purpose computer or in any other circuits or systems.

The processing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The processing device 700 may include one or more communication connections allowing communications with other computing or processing devices 750. Examples of suitable communication connections include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the processing device 700. Any such computer storage media may be part of the processing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The exemplary systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a non-transitory storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, sub-combinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method comprising:
obtaining a plurality of candidate answers for a question;
determining, based on the plurality of candidate answers and a plurality of counts of the plurality of candidate answers, distribution information of the plurality of candidate answers; and
determining, based on the plurality of candidate answers and the distribution information of the plurality of candidate answers, an answer for the question.

2. The method according to claim 1, wherein determining, based on the plurality of candidate answers and the distribution information of the plurality of candidate answers, the answer for the question comprises:
determining, based on the plurality of candidate answers and the distribution information of the plurality of candidate answers, at least one common incorrect answer predicted by a first model; and
determining, based on the plurality of candidate answers, the distribution information of the plurality of candidate answers and the at least one common incorrect answer predicted by the first model, the answer for the question.

3. The method according to claim 2, wherein determining, based on the plurality of candidate answers, the distribution information of the plurality of candidate answers and the at least one common incorrect answer predicted by the first model, the answer for the question comprises:
determining, based on the at least one common incorrect answer, distribution information of the at least one common incorrect answer; and
determining, based on the plurality of candidate answers, the distribution information of the plurality of candidate answers and the distribution information of the at least one common incorrect answer, the answer for the question.

4. The method according to claim 3, wherein determining, based on the plurality of candidate answers, the distribution information of the plurality of candidate answers and the distribution information of the at least one common incorrect answer, the answer for the question comprises:
reducing, based on the distribution information of the plurality of candidate answers and the distribution information of the at least one common incorrect answer, at least one first weight of the at least one common incorrect answer for the answer for the question.

5. The method according to claim 4, wherein determining, based on the plurality of candidate answers, the distribution information of the plurality of candidate answers and the distribution information of the at least one common incorrect answer, the answer for the question comprises:
determining, based on the plurality of candidate answers, the distribution information of the plurality of candidate answers and the at least one reduced first weight of the at least one common incorrect answer, the answer for the question.

6. The method according to claim 5, wherein the answer for the question is an answer with a highest first weight among the plurality of candidate answers.

7. The method according to claim 4, wherein reducing, based on the distribution information of the plurality of candidate answers and the distribution information of the at least one common incorrect answer, at least one first weight of the at least one common incorrect answer for the answer for the question comprises:
reducing, based on the distribution information of the plurality of candidate answers, the distribution information of the at least one common incorrect answer and at least one second weight for the distribution information of the at least one common incorrect answer, the at least one first weight of the at least one common incorrect answer,
wherein the at least one second weight controls contribution of the at least one common incorrect answer for the answer for the question.

8. The method according to claim 7, wherein the at least one second weight is determined based on at least one of:
the distribution information of the plurality of candidate answers;
the distribution information of the at least one common incorrect answer;
distribution information of ground-truth answers; and
distribution information of at least one ground-truth common incorrect answer,
wherein the distribution information of ground-truth answers is determined based on the distribution information of the plurality of candidate answers, and the distribution information of at least one ground-truth common incorrect answer is determined based on the distribution information of the at least one common incorrect answer.

9. The method according to claim 1, wherein the distribution information of the plurality of candidate answers comprises at least one of at least one common answer, at least one common incorrect answer, at least one sample of unique answers, frequency of answers, and answer variance.

10. The method according to claim 1, wherein determining, based on the plurality of candidate answers and the distribution information of the plurality of candidate answers, the answer for the question comprises:
determining, based on the plurality of candidate answers and the distribution information, a plurality of updated candidate answers and distribution information of the plurality of updated candidate answers; and
determining, based on the plurality of updated candidate answers and the distribution information of the plurality of updated candidate answers, the answer for the question.

11. The method according to claim 1, wherein obtaining the plurality of candidate answers for the question and distribution information of the plurality of candidate answers comprises:
determining, by a first model and based on the question, the plurality of candidate answers and distribution information of the plurality of candidate answers for the question iteratively.

12. The method according to claim 11, wherein the first model comprises a plurality of models.

13. The method according to claim 1, further comprising:
acquiring a plurality of training answers for the question; and
training, based on the plurality of training answers, a first model by identifying at least one non-common incorrect new answer from the first model.

14. The method according to claim 13, wherein training, based on the plurality of training answers, the first model by identifying at least one non-common incorrect new answer from the first model comprises:
in response the at least one non-common incorrect new answer being identified, rewarding a first reward value greater than zero for the at least one non-common incorrect answers.

15. The method according to claim 14, wherein training, based on the plurality of training answers, the first model by identifying at least one non-common incorrect new answer from the first model further comprises at least one of:
in response to at least one correct new answer from the first model being identified, rewarding a second reward value for the at least one correct new answer; and
in response to the at least one common incorrect new answer from the first model being identified, rewarding a third reward value for the at least one common incorrect new answer.

16. The method according to claim 15, wherein the second reward value equals 1, the first reward value is less than 1, and the third reward value equals zero.

17. An electronic device, comprising:
a memory and one or more processors;
wherein the memory is configured to store one or more computer instructions which, when executed by the one or more processors, cause the one or more processors to:
obtain a plurality of candidate answers for a question;
determine, based on the plurality of candidate answers and a plurality of counts of the plurality of candidate answers, distribution information of the plurality of candidate answers; and
determine, based on the plurality of candidate answers and the distribution information of the plurality of candidate answers, an answer for the question.

18. The method according to claim 17, wherein the one or more computer instructions causing the one or more processors to determine, based on the plurality of candidate answers and the distribution information of the plurality of candidate answers, the answer for the question comprises instructions to:
determine, based on the plurality of candidate answers and the distribution information of the plurality of candidate answers, at least one common incorrect answer predicted by a first model; and
determine, based on the plurality of candidate answers, the distribution information of the plurality of candidate answers and the at least one common incorrect answer predicted by the first model, the answer for the question.

19. The method according to claim 18, wherein the one or more computer instructions causing the one or more processors to determine, based on the plurality of candidate answers, the distribution information of the plurality of candidate answers and the at least one common incorrect answer predicted by the first model, the answer for the question comprises instructions to:
determine, based on the at least one common incorrect answer, the distribution information of the at least one common incorrect answer; and
determine, based on the plurality of candidate answers, the distribution information of the plurality of candidate answers and the distribution information of the at least one common incorrect answer, the answer for the question.

20. A non-transitory computer-readable medium comprising instructions stored thereon which, when executed by one or more processors, cause the one or more processors to:
obtain a plurality of candidate answers for a question;
determine, based on the plurality of candidate answers and a plurality of counts of the plurality of candidate answers, distribution information of the plurality of candidate answers; and
determine, based on the plurality of candidate answers and the distribution information of the plurality of candidate answers, an answer for the question.
